(19) United States
(12) Patent Application Publication
(10) Pub. No.: US 2021/0371693 A1
(43) Pub. Date: Dec. 2, 2021

(54) TWO-COMPONENT (2K) CLEARCOAT AND METHOD TO COAT A SUBSTRATE WITH THE TWO-COMPONENT (2K) CLEARCOAT HAVING ENHANCED VISUAL APPEARANCE

(71) Applicant: BASF Coatings GmbH, Muenster (DE)

(72) Inventors: David J. Law, Southfield, MI (US); Kevin Michael Turley, Southfield, MI (US); Robert Ringe, Southfield, MI (US)

(21) Appl. No.: 16/637,306

(22) PCT Filed: Jul. 25, 2018
(86) PCT No.: PCT/EP2018/070195

§ 371 Date: Feb. 7, 2020

(30) Foreign Application Priority Data
Aug. 9, 2017 (EP) 17185449.0

(51) Int. Cl. C09D 133/02; C09D 5/28; C08G 18/73; C08G 18/80; B05D 7/00; B05D 5/06

(52) U.S. Cl. CPC C09D 133/02; C09D 5/28; B05D 5/062; C08G 18/807; B05D 7/534; C08G 18/73

(57) ABSTRACT

Provided herein is a two-component clearcoat composition that contains a first component comprising a hydroxyl-functional resin; and a second component comprising a crosslinking agent which is a first isocyanate resin which is unblocked; wherein at least one of the first component and the second component further comprises a blocked isocyanate resin which is a reacted form of a second isocyanate resin and a blocking agent; and wherein the first isocyanate resin and the second isocyanate resin are capable of reacting with the hydroxyl-functional resin to form a crosslinked coating. Further provided herein is a substrate coated with the clearcoat composition that exhibits improved visual appearance to the coated substrate, such as reduced orange peel and an increased balance value.

### BACKGROUND OF THE DISCLOSURE

### Technical Field

The present invention relates to a two-component (2K) clearcoat composition comprising a hydroxyl-functional resin component, an isocyanate resin which is not blocked as crosslinking agent component, and a blocked isocyanate portion distributed between these two components. The disclosure is further directed to a process of coating a substrate with the two-component (2K) clearcoat composition and a substrate coated with the clearcoat composition which provides improved visual appearance to the coated substrate, such as reduced orange peel.

### Description of the Related Art

Coating compositions are utilized to form coatings, such as, for example, primers, basecoats and clearcoats, for protective and decorative purposes. The coatings can be used on buildings, machineries, equipment's, vehicles as automotive original equipment manufacturer (OEM) and refinish coatings, or in other coating applications. The coating can provide one or more protective layers for the underlying substrate and can also have an aesthetically pleasing value.

In typical automotive coatings, at least four layers are applied to the metal surface of a vehicle: an e-coat, a primer, a basecoat, and a clearcoat. The e-coat and the primer layers are generally applied to the vehicle surface and cured. Subsequently, a basecoat formulation is applied with solvent, and the solvent is flashed off in a high temperature process. After properly conditioning the basecoat, the clearcoat is applied next to provide the vehicle with a glossy finish and to protect against corrosion. Lastly, the coated vehicle surface is passed through an oven at high temperatures to cure the basecoat and clearcoat.

The paint finish of a car has two main requirements: protect the surface underneath and enhance the overall product. The total appearance and the visibility of structures depend on the structure size, the observing distance and the image forming quality. The waviness of automotive paints is in a range of approximately 0.1 to 30 mm wavelength. Surfaces with different structure sizes will appear visually different. These phenomena are often visually evaluated and subjective terms like degree of peel or texture are used as descriptions. Original equipment manufacturers (OEM) and their paint suppliers are continually seeking formulations to improve visual appearance. The increase in the visibility of larger wavelength peel is referred to in the industry as orange peel. Orange peel can be seen on high gloss surfaces as a wavy pattern of light and dark areas. Depending on the slope of the structure element the light is reflected in various directions. Only the elements reflecting the light in the direction of the observer's eyes are perceived as light areas. This long wavelength nonuniformity (or structure) of the surface is known to be objectionable to the consumer because it is visible even at long viewing distances of one meter or more. Shorter wavelength structure, on the other hand, is not readily visible at longer viewing distance beyond 0.5 meters provided it is not too severe. It has been shown that an increase in the short wavelength structure may actually aid in masking the sharpness of the reflections that are a result of the long wavelength nonuniformity. Hence, as the long wavelength structure increases, for example on vertical surfaces, it is desirable that the short wavelength structure also increase. Specifically, an improved ratio of longwave (LW) to shortwave (SW) as measured by a wavescan device is considered advantageous. This ratio is also referred to as balance,

Furthermore, it has long been observed that two component (2K) polyisocyanate clearcoats have low levels of short wavelength structure. This has traditionally been seen as desirable and termed as a “wet look”. However, it is now known that this lack of short wavelength structure results in an increase in the perceived amount of long wavelength structure. This is especially true on colors such as black, General methods to increase structure in clearcoats such as selection of a faster evaporating solvent or addition of colloidal materials for sag resistance have been shown to affect both the longwave and shortwave structures. Therefore, in a multilayer system of a two component polyisocyanate clearcoat over black basecoat. it would be desirable to increase the shortwave structure without significantly increasing the longwave structure.

On colors such as silver, the larger pigment size causes irregularities in the basecoat-clearcoat composite film that will increase the shortwave structure, Thus, the same clearcoat that is too low in shortwave structure for a black basecoat may be in the specified range over a silver metallic basecoat. As it is common practice to use the same clearcoat over all colors, a significant increase in the shortwave structure over a silver basecoat would result in too much shortwave for this color. Therefore, it would be desirable to have a clearcoat that increased the shortwave structure over a black basecoat while having little to no effect on the shortwave structure over a silver metallic basecoat.

The present disclosure provides a clearcoat composition that possesses both of these desired, but seemingly contrary, characteristics, This composition is, firstly suitable for increasing the shortwave structure over a black basecoat without significantly increasing the longwave structure, and secondly suitable for increasing the shortwave structure over a black basecoat without significantly increasing the shortwave structure over a silver metallic basecoat.

In view of the forgoing, one aspect of the present disclosure is to provide two-component (2K) clearcoat compositions comprising a hydroxyl-functional resin component, an isocyanate resin which is not blocked as crosslinking agent component, and a blocked isocyanate portion distributed between these two components. During the cross-linking reaction and curing, the delayed release of the second isocyanate ideally retards the curing rate allowing for the formation of surface textures that are more visually desirable (i,e. improved balance value, decreased or constant longwave value, increased shortwave value). According to an additional aspect, the disclosure is further directed to a process of coating a substrate with the two-component (2K) clearcoat composition and a substrate coated with the clearcoat composition having improved visual appearance such as reduced orange peel, and balance value.

### BRIEF SUMMARY OF THE DISCLOSURE

According to a first embodiment, the present disclosure relates to a two-component clearcoat composition comprising a first component comprising a hydroxyl-functional resin; a second component comprising a crosslinking agent being a first isocyanate resin which is not blocked; and a blocked isocyanate resin which is a reacted form of a second isocyanate resin and a blocking agent; wherein the first component comprises the blocked isocyanate resin, the second component comprises the blocked isocyanate resin or the first and the second component comprise the blocked isocyanate resin, and the first isocyanate resin and the second isocyanate resin are capable of reacting with the hydroxyl-functional resin to form a crosslinked coating,

In one aspect of the first embodiment a content of the hydroxyl-functional resin is from 10 to 90 percent by weight; a content of the first isocyanate resin is from 25 to 75 percent by weight: and a content of the blocked isocyanate resin is from 0.1 to 15 percent by weight; wherein the per cent by weight values are based on a total weight of resin solids of the first and second components, and a Wb value of structures of 0.3 to l mm wavelength as measured by a wavescan device of the crosslinked coating after curing on a substrate coated with a black basecoat is increased 4 units or more relative to an otherwise identical two-component clearcoat composition lacking the blocked isocyanate resin; and a Wd value of structures of 3.0 to 10.0 mm wavelength as measured by a wavescan device of the crosslinked coating after curing on a substrate coated with a black basecoat is decreased by less than or equal to 4 units relative to an otherwise identical two-component clearcoat composition lacking the blocked isocyanate resin while having the same molar amount of total isocyanate. Throughout the various embodiments and description which follows per cent solids is determined by ASTM D2369.

In a further aspect of the first embodiment the hydroxyl-functional resin comprises at least one of a hydroxyl-functional acrylic resin and a hydroxyl-functional polyester resin,

In a further aspect of the first embodiment the first isoqanate resin, the second isocyanate resin, or both are polyisocyanate resins comprising at least one diisocyanate selected from the group consisting of toluene diisocyanate, diphenylmethane-4,4′-diisocyanate, diphenylmethane-2,4′-diisocyanate, hexamethvlene diisocyanate, bis(4-isocyanatocyclohexyl) methane, and isophorone diisocyanate.

In a further aspect of the first embodiment the blocking agent for the second isocyanate resin is at least one compound selected from the group consisting of an alkyl alcohol, an ether alcohol, diethylmalonate, an oxime, an amine, preferably imidazole or dimethylpyrazole, an amide, and a hydroxylamine.

In a further aspect of the first embodiment a balance value as measured by a wavescan device of the crosslinked coating after curing on a substrate coated with a black basecoat is increased relative to an otherwise identical two-component clearcoat composition lacking the blocked isocyanate resin while having the same molar amount of total isocyanate.

In a further aspect of the first embodiment a balance value as measured by a wavescan device of the crosslinked coating after curing on a substrate coated with a basecoat is −4 to 6.

In a further aspect of the first embodiment a 20° gloss value of the crosslinked coating after curing on a substrate coated with a basecoat is greater than 80 gloss units.

In a second embodiment a method of forming a coated substrate with the two-component clearcoat composition according the first embodiment and all aspects thereof is provided. The method comprises: coating a surface of the substrate with a basecoat composition to obtain a basecoat layer; at least partially drying the basecoat layer; preparing a two-component clearcoat composition by mixing the first and second components of the two-component clearcoat composition with an organic solvent thereby forming a clearcoat composition; applying the clearcoat composition to a surface of the basecoat layer to form a clearcoat composition layer;

reacting and curing the hydroxyl-functional resin with the first isocyanate resin and the second isocyanate resin obtained by unblocking the blocked isocyanate resin during the curing to form a polyurethane clearcoat coating layer on the basecoat layer; wherein a delayed reaction of the second isocyanate resin during the reacting and the curing reduces a rate of cure of the polyurethane clearcoat coating layer such that a wrinkle is formed between the basecoat layer and the polyurethane clearcoat coating layer.

In an aspect of the second embodiment a content of the blocked isocyanate resin in the clearcoat composition is from 2 to 10 percent by weight, based on the total weight of resin solids in the clearcoat composition.

In a further aspect of the second embodiment the curing is performed at a temperature of 80-150° C. for a time period of 15-45 minutes.

In a third embodiment a coated substrate obtained by the method according to the second embodiment and all aspects thereof is provided. According to this embodiment, the basecoat is black and an increased Wb value of structures of 0.3 to 1.0 mm wavelength and a decreased or equal Wd value of structures of 3.0 to 10.0 mm wavelength is obtained. The Wb and Wd values are measured by a wavescan device and are relative to an otherwise identical coated substrate obtained by an otherwise identical method having the same total molar amount of isocyanate while lacking the blocked isocyanate resin.

In a fourth embodiment a coated substrate obtained by the method according to to the second embodiment and all aspects thereof is provided. According to this embodiment, the basecoat is silver metallic and the coated substrate has an increased Wb value of structures of 0.3 to 1.0 mm wavelength as measured by a wavescan device of less than 4 units relative to an otherwise identical method having the same total molar amount of isocyanate while lacking the blocked isocyanate resin.

A fifth embodiment provides a kit, comprising: a first component comprising a hydroxyl-functional resin; a second component comprising a crosslinking agent being a first isocyanate resin which is not blocked; and a blocked isocyanate resin which is a reacted form of a second isocyanate resin and a blocking agent; wherein the first component comprises the blocked isocyanate resin, the second component comprises the blocked isocyanate resin or the first and the second component comprise the blocked isocyanate resin, and the first isocyanate resin and the second isocyanate resin are capable of reacting with the hydroxyl-functional resin to form a crosslinked coating.

In an aspect of the fifth embodiment, a content of the hydroxyl-functional resin is from 10 to 90 percent by weight; a content of the first isocyanate resin is from 25 to 75 percent by weight; and a content of the blocked isocyanate resin is from 0.1 to 15 percent by weight; wherein the per cent by weight values are based on a total weight of resin solids of the first and second components, and a Wb value of structures of 0.3 to 1.0 mm wavelength as measured by a wavescan device of the crosslinked coating after curing on a substrate coated with a black basecoat is increased 4 units or more relative to an otherwise identical two-component clearcoat composition lacking the blocked isocyanate resin while having the same molar amount of total isocyanate.: and a Wd value of structures of 3.0 to 10.0 mm wavelength as measured by a wavescan device of the crosslinked coating after curing on a substrate coated with a black basecoat is decreased by less than or equal to 4 units relative to an otherwise identical two-component clearcoat composition lacking the blocked isocyanate resin while having the same molar amount of total isocyanate.

The foregoing paragraphs have been provided by way of general introduction, and are not intended to limit the scope of the following claims. The described embodiments, together with further advantages, will be best understood by reference to the following detailed description taken in conjunction with the accompanying drawings.

### DETAILED DESCRIPTION OF THE EMBODIMENTS

Within the description of this disclosure, all cited references, patents, applications, publications and articles that are under authorship, joint authorship or ascribed to members of the Assignee organization are incorporated herein by reference. Where a numerical limit or range is stated, the endpoints are included. Also, all values and subranges within a numerical limit or range are specifically included as if explicitly written out. As used herein, the words “a” and d the like carry the meaning of “one or more.” The phrases “selected from the group consisting of,” “chosen from,” and the like include mixtures of the specified materials. Terms such as “contain(s)” and the like are open terms meaning ‘including at least’ unless otherwise specifically noted. All other terms are interpreted according to the conventional meaning understood by one of skill in the art,

According to a first embodiment, the present disclosure relates to a two-component clearcoat composition comprising a first component comprising a hydroxyl-functional resin; a second component comprising a crosslinking agent being a first isocyanate resin which is not blocked; and a blocked isocyanate resin which is a reacted form of a second isocyanate resin and a blocking agent; wherein the first component comprises the blocked isocyanate resin, the second component comprises the blocked isocyanate resin or the first and the second component comprise the blocked isocyanate resin, and the first isocyanate resin and the second isocyanate resin are capable of reacting with the hydroxyl-functional resin to form a crosslinked coating. The isocyanate group can react with any compound containing reactive hydrogen.

Reaction of an isocyanate with an alcohol (i.e. hydroxyl-functionality) yields a urethane. In order to prepare polymeric materials, the reaction partners require at least two functional groups per molecule, Linear polymers are formed when both reaction partners are difunctional. Three dimensional networks require that at least one of the reaction partners has three or more reactive groups. In a preferred embodiment, the two-component clearcoat composition may be provided to a customer or user as two separate components and mixed just prior to application.

The two-component clearcoat composition of the present disclosure comprises a first component comprising a hydroxyl-functional resin. The hydroxyl-functional resin of the first component of the two-component coating composition of the present disclosure may be any polymer having a hydroxyl functionality that is reactive with functional groups of the crosslinking agent or first isocyanate resin.

In a preferred embodiment, the hydroxyl-functional resin is a hydroxyl-functional acrylic resin or a hydroxyl-functional polyester, preferably the hydroxyl-functional resin is at least one member selected from the group consisting of an acrylic polymer having a hydroxyl functionality and a polyester polymer having a hydroxyl functionality. In a more preferred embodiment, the hydroxyl-functional resin is an acrylic polymer having a hydroxyl functionality. Exemplary commercially available hydroxyl-functional resins include those sold under the tradename JONCRYL®.

In certain embodiments, in addition to the hydroxyl-functional group, the hydroxyl-functional resin may comprise a further reactive functionality provided it is reactive with the functional groups of the crosslinking agent, the first isocyanate resin, of the second component. In certain embodiments, the hydroxyl-functional resin includes at least one further functionality selected from the group consisting of an amine functionality, a carboxylic acid functionality, a carbamic acid functionality, and an epoxy functionality,

The hydroxyl-functional resin present in the first component of the two-component clearcoat composition may, in general, have any glass transition temperature (Tg) which, in combination with the sition temperature of the crosslinking agent, the first isocyanate resin, of the second component and the equivalent weight of the hydroxyl-functional resin, results in the formation of a cured film having a desired hardness. In a preferred embodiment, the hydroxyl-functional resin has a glass transition temperature of from −20° C. to 100° C., preferably from 0° C. to 75° C., preferably from 10° C. to 50° C.

Copolymer Tg values are calculated from the Tg values of the homopolymers of the comonomers contained therein using the Fox equation. The homopolymer Tg values are obtained from the Polymer Handbook, Third Edition, J. Brandup, L H. Immergut, Chapter V I, pages 215-225. The Fox equation is based on the weight fraction of each comomomer and the Tg of its corresponding homopolymer as follows:

$$Tg of copolymer [ {K}^{o} ] = {[ {\sum }_{i comonomer} \frac{{w}_{i}}{{Tg}_{i}} ]}^{- 1}$$

$${w}_{i} = weight fraction of monomer i$$

$${Tg}_{i} = homopolymer Tg of monomer i [ {K}^{o} ]$$

In certain embodiments, he hydroxyl-functional resin present in the first component of the two-component coating composition may have a number average molecular weight (Mn), as measured by gel permeation chromatography (GPC) against an unbranched polystyrene standard, from 500 to 30,000, or from 600 to 20,000, or from 750 to 10,000. The hydroxyl-functional resin may have a hydroxyl equivalent rate (i.e. grams of hydroxyl-functional resin per equivalent of OH) from 100 to 3000, preferably 200 to 1500, preferably 250 to 800, preferably 300 to 700 grams of hydroxyl-functional resin per equivalent of OH. Note: The GPC method is described in more detail in the Experimental section which follows.

In a preferred embodiment, exemplary suitable hydroxyl-functional acrylic resins or hydroxyl-functional polyester resins will have sufficient hydroxyl contents for reactivity at the desired curing temperatures of 80 to 150° C., preferably 85-145° C., preferably 90-140° C., preferably 95-135° C., preferably 100-130° C., preferably 110-130° C. In a preferred embodiment, the hydroxyl-functional acrylic resins may have a hydroxyl number of from 15 to 565 mg KOH/g, preferably from 35 to 280 mg KOH/g, preferably 70 to 225 mg KOH/g. In certain embodiments, the hydroxyl number may be less than 200 mg KOH/g, such as, for example, less than 185 mg KOH/g, or less than 175 mg KOH/g. In a preferred embodiment, the hydroxyl-functional acrylic resins have an average of at least two active hydrogen groups per molecule. In a preferred embodiment, the hydroxyl-functional resin is present in the two-component coating composition in an amount ranging from 10 to 90 percent by weight based on a total weight of combined resin solids in the composition, preferably from 30 to 80 percent by weight, preferably from 35 to 70 percent by weight, preferably from 45 to 65 percent by weight based on a total weight of combined resin solids in the composition. The two-component clearcoat composition of the present disclosure comprises a second component comprising a crosslinking agent which is a first isocyanate resin. The first isocyanate resin has free NCO groups that react with the hydroxyl groups of the hydroxyl-functional resin to form urethane linkages (—NH—CO—O—) and thus a crosslinked urethane coating.

In certain embodiments, the first isocyanate resin may have a number average molecular weight (Mn), as measured by gel permeation chromatography (GPC) against an unbranched polystyrene standard. from 100 to 20,000, preferably from 150 to 10,000, preferably from 200 to 5,000. The first isocyanate resin may have an NCO equivalent weight (i.e. grams of crosslinking agent per equivalent of NCO) from 50 to 1000, preferably from 100 to 500, preferably from 150 to 250.

As used herein, the first isocyanate resin may be any organic isocyanate that is suitable for crosslinking the hydroxyl-functional resin of the first component comprising a hydroxyl-functional resin of the two-component coating composition of the present disclosure. The isocyanate, preferably polyfunctional isocyanate, may be aromatic aliphatic, cycloaliphatic, or polycyclic in structure. Preference is given to isocyanates containing from 3 to 36, preferably 4 to 16, preferably 6 to 15, preferably from 8 to about 12 carbon atoms.

Exemplary diisocyanates suitable as the first isocyanate resin include, but are not limited to, toluene diisocyanate (TDI), diphenylmethane-4,4′-diisocyanate (MDI), diphenylmethane-2,4′-diisocyanate, trimethylene diisocyanate, tetramethylene diisocyanate, pentamethylene diisocyanate, hexamethylene diisocyanate (HDI), propylene diisocyanate, ethylethylene diisocyanate, 2,3-dimethylethylene diisocyanate, 1-methyltrimethylene diisocyanate, 1,3-cyclopentylene diisocyanate, 1,4-cyclohexylene diisocyanate, 1,2-cyclohexylene diisocyanate, 1,3-phenylene diisocyanate, 1,4-phenylene diisocyanate, 2,4-toluylene diisocyanate, 2,6-toluylene diisocyanate, 4,4′-dicyclohexylmethane diisocyanate (H₁₂MDI), xylene diisocyanate (XDI), hydrogenated xylene diisocyanate (HXDI), naphthalene 1,5-diisocyanate (ND1),p-phenylene diisocyanate (PPDI), 3,3′-dimethyldiphenyl-4,4′-diisocyanate (DDDI), 2,2,4-trimethyl-hexamethylen diisocyanate (TMDI), nobomane diisocyanate (NDI), 4,4′-dibenzyl diisocyanate (DBDI), 4,4-diphenylene diisocyanate (e.g. 4,4′-methylene bisdiphenyldiisocyanate), 1,5-naphthylene diisocyanate, 1,4-naphthylene diisocyanate, 1-isocyanatomethyl-3-isocyanato-3,5,5-trimethylcyclohexane (isophorone diisocyanate or IPDI), 1,3-bis(1-isocyanato-1-methylethyl)benzene (m-tetramethylxylene diisocyanate or TMXDI), bis(4-isocyanatocyclohexyl)methane, bis(4-isocyanatophenyl)methane, 4,4′-diisocyanatodiphenyl ether and 2,3-bis(8-isocyanatoodyl)-4-octyl-5-hexylcyclohexane.

Of these, hexamethylene diisocyanate (HDI), toluene diisocyanate (TDI), diphenylmethane-4,4′-diisocyanate (MDI), diphenylmethane-2,4′-diisocyanate, bis(4-isocyanatocyclohexyl) methane, isophorone diisocyanate (IPDI), and m-tetramethylxylene diisocyanate (TMXDI) are preferred. In a preferred embodiment, the first isocyanate resin, the second isocyanate resin, or both comprise at least one diisocyanate selected from the roup consisting of toluene diisocyanate, diphenylmethane-4,4′-diisocyanate, diphenylmethane-2,4′-diisocyanate, hexamethylene diisocyanate, bis(4-isocyanatocyclohexyl) methane, and isophorone diisocyanate.

In certain embodiments, it is equally envisaged that polyfunctional isocyanates of higher isocyanate functionality than diisocyanates may be employed. Exemplary polyfunctional isocyanate of higher isocyanate functionality than diisocyanates include, but are not limited to, TDI based polyisocyanates, MDI based polyisocyanates, HDI based polyisocyanates, IPDI based polyisocyanates, tris(4-isocyanatophenyl)methane, 1,3,5-triisocyanatobenzene, 2,4,6-triisocyanatotoluene, 1,3,5-tris(6-isocyanatohexylbiuret), bis(2,5-diisocyanato-4-methylphenyl)methane, 1,3,5-tris(6-isocyanatohexyl)-1,3,5-triazinane-2,4,6-trione hexamethylene diisocyanate cyclic trimer), 1,3,5-tris(6-isocyanatohexyl) and polymeric polyisocyanates, such as dimers and trimers of diisocyanatotoluene. In certain embodiments, the first isocyanate resin employed as the crosslinking agent of the second component may additionally be in the form of prepolymers which are derived for example from a polyol, including, but not limited to, a polyether polyol or a polyester polyol.

In a preferred embodiment, the blocked isocyanate resin is present in the two-component clearcoat composition in an amount ranging from 25 to 75 percent by weight based on a total weight of combined resin solids in the composition, preferably from 35 to 65 percent by weight, and more preferably from 45 to 55 percent by weight, based on a total weight of combined resin solids in the composition.

In a preferred embodiment, the first isocyanate resin is substantially unblocked, meaning that more than 90% of the NCO groups are unblocked and may react with the hydroxyl-functionality, preferably more than 95%, preferably more than 99%, or more than 99.5% of the NCO groups are unblocked and may react with the hydroxyl-functionality. In certain embodiments, the first isocyanate resin may be completely devoid of blocked NCO groups.

The two-component clearcoat composition of the present disclosure comprises a first component comprising a hydroxyl-functional resin and a second component comprising a crosslinking agent which is a first isocyanate resin, wherein at least one of the first component and the second component further comprises a blocked isocyanate resin which is a reacted form of a second isocyanate resin and a blocking agent. At room temperature these blocked isocyanates do not react with hydroxyl groups at any appreciable rate. At elevated temperatures the blocked isocyanate liberates the blocking agent (i.e. unblocks) and the isocyanate functionality may react with the hydroxyl-functionality.

The second isocyanate resin included in the two-component clearcoat composition of the present disclosure is the same as those described above for the first isocyanate resin. In certain embodiments, the first isocyanate resin and the second isocyanate resin may be the same. In certain embodiments, the first isocyanate resin and the second isocyanate resin may be different. In a preferred embodiment, the first isocyanate resin, the second isocyanate resin, or both comprise at least one diisocyanate selected from the group consisting of toluene diisocyanate, diphenylmethane-4,4′-diisocyanate, diphenylmethane-2,4′-diisocyanate, hexamethylene diisocyanate, bis(4-isocyanatocyclohexyl) methane, and isophorone diisocyanate.

In certain embodiments. the blocked isocyanate resin is substantially blocked, meaning that more than 90% of the NCO groups are blocked, preferably more than 95%, preferably more than 99%, or more than 99.5% of the NCO groups are blocked. In certain embodiments, the blocked isocyanate resin may be completely devoid of free NCO groups.

Throughout this description the term unblocked isocyanate resin describes a resin having isocyanate groups available for reaction with isocyanate reactive functional groups. This reactivity may also be referenced with the term “live” such that unblocked and live may be used interchangeably to describe the isocyanate resin.

In certain embodiments, the blocked isocyanate resin may have a number average molecular weight (Mn), as measured by gel permeation chromatography (GPC) against an unbranched polystyrene standard, from 150 to 30,000, preferably 200 to 20,000, preferably 250 to 10,000. The blocked isocyanate may have an NCO equivalent weight (i.e. grams of crosslinking agent per equivalent of NCO) from 50 to 1000, preferably from 100 to 500, preferably from 150 to 250.

The blocking agents may be employed individually or in combination. In certain embodiments, the blocking agent may be any compound with active hydrogen. In a preferred embodiment, the blocking agent is at least one selected from the group consisting of an alkyl alcohol, an ether alcohol, an oxime, an amine, an amide, and a hydroxylamine.

Exemplary suitable alkyl alcohol blocking agents include, but are not limited to, aliphatic, cycloaliphatic or aromatic alkyl monoalcohols having 1-20 carbon atoms in the alkyl group, such as, for example, methanol, ethanol, n-propanol, butanol, pentanol, hexanol, heptanol, octanol, nonanol, 2-ethyl hexanol, 3,3,5-trimethylhexan-1-ol, cyclopentanol, cyclohexanol, cyclooctanol, phenol, pyridinol, thiophenol, cresol, phenylcarbinol, and methylphenylcarbinol. Polyfunctional alcohols such as glycerol and trimethylolpropane may also be employed as a blocking agent.

Exemplary suitable ether alcohol blocking agents include, but are not limited to, ethylene glycol mono alkyl ether, diethylene glycol mono alkyl ether, propylene glycol mono alkyl ether or dipropylene glycol mono alkyl ether with alkyl group of 1-10 carbon atoms, such as, for example, diethylene glycol mono butyl ether, ethylene glycol butyl ether, diethylene glycol mono methyl ether, ethylene glycol methyl ether, dipropylene glycol mono methyl ether, dipropylene glycol mono butyl ether, propylene glycol mono butyl ether, and propylene glycol mono methyl ether.

Exemplary suitable oxime blocking agents include, but are not limited to, methyl ethyl ketone oxime, methyl isopropyl ketone oxime, methyl isobutyl ketone oxime, methyl isoamyl ketone oxime, methyl n-amyl ketone oxime, methyl 2-ethylhexyl ketone oxime, cyclobutanone oxime, cyclopentanone oxime, cyclohexanone oxime, 3-pentanone oxime, 2,4-dimethyl-3-pentanone oxime (i.e., diisopropyl ketone oxime), diisobutvl ketone oxime, di-2-ethylhexyl ketone oxime, acetone oxime, formaldoxime, acetaldoxime, propionaldehyde oxime, butyraldehyde oxime, glyoxal monoxime, and diacetyl monoxime.

Exemplary suitable amine blocking agents include, but are not limited to, dibutylamine and diisopropylamine. Exemplary suitable amide blocking agents include, but are not limited to, caprolactam, methvlacetamide, succinimide, and acetanilide. An exemplary suitable hydroxylamine blocking agent is ethanolamine.

In a preferred embodiment, the blocking agent is at least one selected from the group consisting of imidazole, dimethylpyrazole, and diethylmalonate. In a more preferred embodiment, the blocked isocyanate resin is a dimethylpyrazole blocked hexamethylene diisocyanate (HDI) which is a reacted form of a second isocyanate resin (HDI) and a blocking agent dimethylpyrazole, such as for example, sold under the tradename Desmodus®, preferably Desmodur PL-350.

In a preferred embodiment, the blocked isocyanate resin is present in the two-component clearcoat composition in an amount ranging from 0.1 to 15 percent by weight based on a total weight of combined resin solids in the composition, preferably 0,5 to 12 percent by weight, preferably 1-11 percent by weight, preferably 2-10 percent by weight, preferably 3-9 percent by weight, preferably 4-8 percent by weight, preferably 5-7 percent by weight based on a total weight of combined resin solids in the composition. Importantly, the blocked isocyanate resin may be present in either the first component, the second component, or both with the proviso that the total sum of blocked isocyanate resin be within the ranges described. Advantageously, in a preferred embodiment, greater than 80% by weight of the blocked isocyanate resin is present in the first component, relative to the total weight of the blocked isocyanate in the two-component clearcoat composition, preferably greater than 82%, preferably greater than 84%, preferably greater than 86%. preferably greater than 88%, preferably greater than 90%, preferably greater than 95% by weight of the blocked isocyanate resin is present in the first component, relative to the total weight of the blocked isocyanate in the two-component clearcoat composition

In a preferred embodiment, the two-component clearcoat composition of the present disclosure in any of its embodiments is a solventbome composition and may contain any of the solvents conventionally known to one of ordinary skill in the art. Exemplary suitable solvents include, but are not limited to, aromatic solvents, such as toluene, xylene, naptha, and petroleum distillates; aliphatic solvents, such as heptane, octane, and hexane; ester solvents, such as butyl acetate, isobutyl acetate, butyl propionate, ethyl acetate, isopropyl acetate, butyl acetate. amyl acetate, hexyl acetate, heptyl acetate, ethyl propionate, isobutylene isobutyrate, ethylene glycol diacetate, and 2-ethoxyethyl acetate; ketone solvents, such as acetone, methyl ethyl ketone, methyl amyl ketone, and methyl isobutyl ketone; lower alcohols, such as methanol, ethanol, isopropanol, n-butanol, 2-butanol; glycol ethers such as ethylene glycol monobutyl ether, diethylene glycol butyl ether; glycol ether esters such as propylene glycol monomethyl ether acetate, ethylene glycol butyl ether acetate, 3-methoxy n-butyl acetate; lactams, such as N-methyl pyrrolidone (NMP); and mixtures thereof. In certain embodiments the solvent may be a VOC exempt solvent such as chlorobromomethane, 1-bromopropane, C₁₂₋₁₈ n-alkanes, t-butyl acetate, perchloroethylene, benzotrifluoride, p-chlorobenzotrifluoride, acetone, 1,2-dichloro-1,1,2-trifluoroethane, dimethoxymethane, 1,1,1,2,2,3,3,4,4-nonalluoro-4-methoxy-butane, 2-(difluoromethoxymethyl)-1,1,1,2,3,3,3-heptafluoroprop e, 1-ethoxy-1,1,2,2,3,3,4,4,4-nonafluorobutane, 2-(ethoxydifluoromethyl)-1,1,1,2,3,3,3-heptafluoropropane, and mixtures thereof. In a preferred embodiment, the solvent of the solventbome two-component clearcoat composition is at least one selected from the group consisting of a lower alcohol (i.e. butanol) and an ester (i.e. t-butyl acetate). Advantageously, a water content of the solventbome two-component clearcoat composition is less than 1 percent by weight, preferably less than 0.5 percent by weight, more preferably less than 1 percent by weight and most preferably the solventborne two-component clearcoat composition is free of water.

In certain embodiments, the two-component clearcoat composition of the present disclosure in any of its embodiments has a total combined resin solids content of at least 20 percent by weight relative to the total combined weight of the solventbome two-component clearcoat composition, preferably at least 25 percent by weight, more preferably at least 30 percent by weight, more preferably at least 35 percent by weight relative to the total combined weight of the solventbome two-component clearcoat composition. In certain embodiments, the two-component clearcoat composition of the present disclosure in any of its embodiments has a total combined resin solids content of no more than 85 percent by weight relative to the total combined weight of the solventbome two-component clearcoat composition, preferably no more than 80 percent by weight, preferably no more than 75 percent by weight, preferably no more than 70 percent by weight, preferably no more than 65 percent by weight, preferably no more than 60 percent by weight relative to the total combined weight of the solventbome two-component clearcoat composition. In certain embodiments, the total diluent (i.e. solvent/organic solvent) content of the solventbome two-component clearcoat composition of the present disclosure in any of its embodiments ranges from at least 5 percent by weight up to 80 percent by weight, preferably at least 10 percent by weight up to 70 percent by weight, and more preferably at least 15 percent by weight up to 50 percent by weight, based on the total weight of solventbome two-component clearcoat composition.

In a preferred embodiment, the first component comprising a hydroxyl-functional resin and optionally a blocked isocyanate resin, the second component comprising a first isocyanate resin and optionally a blocked isocyanate resin, or both are solventbome and may contain any of the solvents conventionally known to one of ordinary skill in the art as previously described. In certain embodiments, the first component comprising a hydroxyl-functional resin and optionally a blocked isocyanate has a combined resin solids content of at least 20 percent by weight relative to the total combined weight of the solventbome first component, preferably at least 25 percent by weight, more preferably at least 30 percent by weight, more preferably at least 35 percent by weight, preferably at least 40 percent by weight, preferably at least 45 percent by weight relative to the total combined weight of the solventbome first component. In certain embodiments, the second component comprising a first isocyanate resin and optionally a blocked isocyanate has a combined resin solids content of at least 20 percent by weight relative to the total combined weight of the solventbome first component, preferably at least 25 percent by weight, more preferably at least 30 percent by weight, more preferably at least 35 percent by weight, preferably at least 40 percent by weight, preferably at least 45 percent by weight relative to the total combined weight of the solventbome second component.

In certain embodiments, it is equally envisaged that the two-component clearcoat composition of the present disclosure in any of its embodiments may further optionally comprise a catalyst, preferably a metal catalyst to promote reaction of the hydroxyl-functional resin and the crosslinking agents in the form of the first isocyanate resin and the second isocyanate resin. Exemplary metal catalysts are well known to those of conventional skill in the art and include, but are not limited to, an organometallic compound selected from aliphatic bismuth carboxylates such as bismuth ethylhexanoate, bismuth subsalicylate (having an empirical formula C₇H₅O₄Bi), bismuth hexanoate, bismuth ethylhexanoate or dimethylol-propionate, bismuth oxalate, bismuth adipate, bismuth lactate, bismuth tartrate, bismuth salicylate, bismuth glycolate, bismuth succinate, bismuth formate, bismuth acetate, bismuth acrylate, bismuth methacrylate, bismuth propionate, bismuth butyrate, bismuth octanoate, bismuth decanoate, bismuth stearate, bismuth oleate, bismuth eiconsanoate, bismuth benzoate, bismuth malate, bismuth maleate, bismuth phthalate, bismuth citrate, bismuth gluconate; bismuth acetylacetonate; bis-(triorgano tin)oxides such as bis(trimethyl tin) oxide, bis(triethyl tin) oxide, bis(tripropyl tin) oxide, bis(tributyl tin) oxide, bis(triamyl tin) oxide, bis(trihexyl tin) oxide, bis(triheptyl tin) oxide, bis(trioctyl tin) oxide, bis(tri-2-ethylhexyl tin) oxide, bis(triphelihyl tin) oxide, bis(triorgano tin)sulfides, (triorgano tin)(diorgano tin) oxides, sulfoxides, and sulfones, bis(triorgano tin)dicarboxylates such as bis(tributyl tin) adipate and maleate; bis(triorgano tin)dimercaptides, triorgano tin salts such as trioctyl tin octanoate, tributyl tin phosphate; (triorgano tin)(organo tin)oxide:

trialkylalkyloxy tin oxides such as trimethylmethoxy tin oxide, dibutyl tin diacetylacetonate, dibutyl tin dilaurate; trioctyl tin oxide, tributyl tin oxide, dialkyl tin compounds such as dibutyl tin oxide, dioctyl tin oxide, dibutyl tin dilaurate, dibutyl tin diacetate, dibutyl tin dimaleate, dibutyl tin distearate, dipropyl tin dioctoate and dioctyl tin oxide; monoalkyl tin compounds such as monobutyltin trioctanoate, monobutyl tin triacetate, monobutyl tin tribenzoate, monobutyl tin trioctylate, monobutyl tin trilaurate, monobutyl tin trimyristate, monomethyl tin triformate, monomethyl tin triacetate, monomethyl tin trioctylate, monooctyl tin triacetate, monooctyl tin trioctylate, monooctyl tin trilaurate; monolauryl tin triacetate, monolauryl tin trioctylate, and monolauryl tin trilaurate; zinc octoate, zinc naphthenate, zinc tallate, zinc carboxylates having from about 8 to 14 carbons in the carboxylate groups, zinc acetate; lithium carboxylates such as lithium acetate, lithium 2-ethylhexanoate, lithium naphthenate, lithium butyrate, lithium isobutyrate, lithium octanoate, lithium neodecanoate, lithium oleate, lithium versatate, lithium tallate, lithium oxalate, lithium adipate, lithi stearate; lithium hydroxide; zirconium alcoholates, such as methanolate, ethanolate, propanolate, isopropanolate, butanolate, tert-butanolate, isobutanolate, pentanolate, neopentanolate, hexanolate and octanolate; zirconium carboxylates such as formate, acetate, propionate, butanoate, isobutanoate, pentanoate, hexanoate, cyclohexanoate, heptanoate, octanoate, 2-ethylhexanoate, nonanoate, decanoate, neodecanoate, undecanoate, dodecanoate, lactate, oleate, citrate, benzoate, salicylate and phenylacetate; zirconium 1,3-diketonates such as acetylacetonate (2,4-pentanedionate), 2,2,6,6-tetramethyl-3,5-heptanedionate, 1,3-diphenyl-1,3-propanedionate (dibenzoylmethanate), 1-phenyl-1,3-butananedionate and 2-acetylcyclohexanonate; zirconium oxinate; zirconium 1,3-ketoesterates, such as methyl acetoacetate, ethyl acetoacetate, ethyl-2-methyl acetoacetate. ethyl-2-ethyl acetoacetate, ethyl-2-hexylacetoacetate, ethyl-2-phenyl-acetoacetate, propyl acetoacetate, isopropyl acetoacetate. butyl acetoacetate, tert-butyl acetoacetate, ethyl-3-oxo-valerate, ethyl-3-oxo-hexanoate, and 2-oxo-cyclohexane carboxylic acid ethyl esterate; zirconium 1,3-ketoamidates, such as N,N-diethyl-3-oxo-butanamidate, N,N-dibutyl-3-oxo-butanamidate, N,N-bis-(2-ethylhexyl)-3-oxo-butanamidate, N,N-bis-(2-methoxyethyl)-3-oxo-butanamidate, N,N-dibutyl-3-oxo-heptanamidate, N,N-bis-(2-methoxyethyl)-3-oxo-heptanamidate, N,N-bis-(2-ethylhexyl)-2-oxo-cyclopentane carboxamidate, N,N-dibutyl-3-oxo-3-phenylpropanamidate, N,N-bis-(2-methoxyethyl)-3-oxo-3-phenylpropanamidate; and combinations of the foregoing metal catalysts.

In a preferred embodiment, the catalyst is a metal catalyst and more preferably a dialkyl tin compound selected from the group consisting of dibutyl tin oxide, dioctyl tin oxide, dibutyl tin dilaurate, dibutyl tin diacetate, dibutyl tin dimaleate, dibutyl tin distearate, dipropyl tin dioctoate, and dioctvl tin oxide, dibutyl tin dilaurate being a highly preferred catalyst.

In certain embodiments, the metal catalyst if present may be from 0.001 to 10 percent by weight based on the total weight of combined resin solids in the composition, preferably from 0.01 to 8 percent by weight, preferably from 0.05 to 7.5 percent by weight, preferably from 0.1 to 6.0 percent by weight, preferably from 1.0 to 5.0 percent by weight based on the total weight of the combined resin solids in the composition. In certain embodiments, the metal catalyst if present may account for less than 5.0 percent by weight based on the total weight the combined resin solids in the composition, preferably less than 2.5 percent by weight, preferably less than 2.0 percent by weight, preferably less than 1.0 percent by weight, preferably less than 0.5 percent by weight, preferably less than 0.1 percent by weight, preferably less than 0.01 percent by weight based on the total weight of the combined resin solids in the composition. In certain embodiments, it is equally envisaged that the two-component clearcoat composition of the present disclosure in any of its embodiments may further optionally comprise one or more additional additives. Exemplary suitable additives include, but are not limited to, surfactants, stabilizers, wetting agents, rheology control agents, dispersing agents, UV absorbers, hindered amine light stabilizers, adhesion promoters, and the like. In a preferred embodiment, these additives may account for 0.1 to 5 percent by weight based on the total weight of combined resin solids in the composition, preferably from 0.5 to 4 percent by weight, preferably from 0.5 to 2.5 percent by weight based on the total weight of the combined resin solids in the composition. In certain embodiments, these additives account for less than 2.5 percent by weight based on the total weight the combined resin solids in the composition, preferably less than 2.0 percent by weight, preferably less than 1.0 percent by weight, preferably less than 0.5 percent by weight, preferably less than 0.25 percent by weight, preferably less than 0.1 percent by weight based on the total weight of the combined resin solids in the composition.

In a preferred embodiment, the two-component clearcoat composition of the present disclosure is intended as translucent and contains less than 1 per cent by weight of colorant. However, as recognized by one of skill in the art, certain pigments, known as extender pigments do not impart color to the solvent borne clearcoat and such pigments may be contained in an amount of less than 5 percent by weight, preferably 2 to 4 percent of the solventborne two-component clearcoat composition.

According to a second aspect, the present disclosure relates to a method of forming a coated substrate, the method comprising i) coating a surface of a substrate with a basecoat composition to obtain a basecoat layer, ii) at least partially drying the basecoat layer, iii) preparing a two-component clearcoat composition by mixing iiia) a first component comprising a hydroxyl-functional resin, iiib) a second component comprising a crosslinking agent which is a first isocyanate resin, and iiic) an organic solvent, wherein at least one of the first component and the second component further comprises a blocked isocyanate which is a reacted form of a second isocyanate resin and a blocking agent thereby forming the clearcoat composition. iv) applying the clearcoat composition to a surface of the basecoat layer to form a clearcoat composition layer, v) reacting and curing the hydroxyl-functional resin with the first isocyanate resin and the second isocyanate resin obtained by unblocking the blocked isocyanate resin during the curing to form a polyurethane clearcoat coating layer thereby forming a coated substrate, wherein the coated substrate comprises a basecoat layer between the substrate and the polyurethane clearcoat coating layer, and wherein a delayed release of the second isocyanate resin during the reacting and the curing reduces a rate of cure of the polyurethane clearcoat coating layer such that a wrinkle is formed between the basecoat layer and the polyurethane clearcoat coating layer.

As used herein, a substrate refers to a substance or layer that underlies something, or on which some process occurs. Suitable substrates include, but are not limited to, wood, fiberglass, metal, glass, cloth, carbon fiber, and polymeric substrates. Exemplary suitable metal substrates that may be coated include, but are not limited to, ferrous metals such as iron, steel, and alloys thereof, non-ferrous metals such as aluminum, zinc, magnesium, and alloys thereof, and combinations thereof. Exemplary suitable polymeric substrates that may be coated include, but are not limited to, thermoplastic materials, such as thermoplastic polyolefins (i.e. polyethylene, polypropylene), polyamides, polyurethanes, polyesters, polycarbonates, acrylonitrile-butadiene-styrene (ABS) copolymers, EPDM rubber, acrylic polymers, vinyl polymers, copolymers and mixtures thereof, preferably thermoplastic polyolefins.

In a preferred embodiment, the substrate is a polymeric substrate, preferably a polymeric substrate found on a motor vehicle, such as, for example, automobiles, trucks, and tractors and the two-component clearcoat composition of the present disclosure in any of its embodiments is particularly useful for coating such automotive polymeric substrates. It is equally envisaged that the two-component clearcoat composition described herein in any of its embodiments may also be applied to molded or shaped articles or components, toys, sporting goods, cases or coverings for electronic devices, and small appliances. Further, these components may have any shape, but preferably are in the form of automotive body components such as bodies (frames), hoods, doors, fenders, bumpers, and/or trim for automotive vehicles.

In terms of the present disclosure, the basecoat composition is not viewed as particularly limiting. In terms of the present disclosure the basecoat may be a solid paint, a metallic paint, and/or a pearlescent paint, further it may be a one component (1K) or two component (2K) formulation and may be either solvent borne or waterborne. In certain embodiments, the basecoat may comprise a melamine formaldehyde crosslinking agent which is reacted with an acid group, such as, for example, a carboxylic acid or sulfonic acid. In addition, the basecoat composition may further comprise catalysts (i.e. strong acid catalysts, organic amines) and additives as described herein.

In a preferred embodiment, the basecoat composition comprises or may be colored with at least one pigment or colorant. Exemplary suitable pigments or colorants include, but are not limited to metal oxides, such as zinc oxide, antimony oxide, iron oxides, titanium dioxide, and lead oxides; carbon black; mica, including mica-based effect pigments; metallic pigments, such as aluminum flakes, bronze flakes, nickel flakes, tin flakes, silver flakes, and copper flakes; and organic pigments, such as phthalocyanines, like copper phthalocyanine blue, perylene red and maroon, quinacridone magenta, dioxazine carbazole violet, and the like.

In certain embodiments, pigments and colorants may account for up to 50 percent by weight relative to the total weight of the combined solids in the basecoat composition, preferably up to 40 percent by weight, preferably up to 30 percent by weight relative to the total weight of the combined solids in the basecoat composition, and may be as low as 10 percent by weight, preferably as low as 5 percent by weight, preferably as low as 1 percent by weight, preferably as low as 0.1 percent by weight relative to the total weight of the combined solids in the basecoat composition. In terms of the total weight of the basecoat composition, the content of the pigment or colorant may range from 5 to 90 percent by weight, preferably from 10 to 70 percent by weight, preferably from 15 to 50 percent by weight relative to the total weight of the basecoat composition.

In one step of the method, a surface of the substrate is coated with a composition to obtain a basecoat layer and the basecoat layer is at least partially dried. After applying the basecoat composition, water or solvent may be partially or completely driven from the basecoat layer by heating or air-drying, for instance a portion of the water or solvent may be partially removed with an ambient and/or force flash that lasts for 1 to 10 minutes, preferably 2-8 minutes, preferably 4-6 minutes and has a temperature of 30 to 90° C., preferably 40 to 80° C., preferably 50 to 70° C., preferably 55 to 65° C., or about 60° C.

In one step of the method, the hydroxyl-functional resin is reacted and cured with the first isocyanate resin and the second isocyanate resin obtained by unblocking the blocked isocyanate resin during the curing to form a polyurethane clearcoat coating layer thereby forming a coated substrate. In a preferred embodiment, the curing is performed at a temperature of 80-150° C., preferably 90-145° C., preferably 100-140° C., preferably 110-135° C., preferably 120-130° C. for a time period of 15-45 minutes, preferably 18-40 minutes, preferably 20-35 minutes, preferably 22-30 minutes, or about 25 minutes.

Although not wishing to be limited by theory, the first isocyanate resin and hydroxyl-functional resin begin to react upon contact and continue reacting (i.e. crosslinking) during the curing at which point the unblocked second isocyanate resin and the hydroxyl-functional resin begin to react (i.e. crosslink). The delayed release of the second isocyanate resin during the reacting and curing reduces a rate of cure of the polyurethane clearcoat coating layer such that a “wrinkle” is formed between the basecoat layer and the polyurethane clearcoat coating layer. The “wrinkle” refers to changes in surface morphology and textures in the fully coated substrate, preferably these changes in surface morphology and textures result in an increased about of short wave structures (i.e. Wb) and a decreased or equal amount of long wave structures , Wd). Thus, the wrinkle provides an improved visual appearance and balance in terms of the ratio of short wave structures to long wave structures.

In a preferred embodiment, each of the basecoat composition and the two-component clearcoat composition are applied to the substrate in order to provide dry film thicknesses of from 5 to 90 μm, preferably from 7.5 to 75 μm, preferably from 10 to 60 μm, preferably from 12.5 to 55 μm, preferably from 15 to 50 μm. For instance, the dry film thickness of the basecoat layer may be from 5 to 35 μm, preferably from 10 to 30 μm, and more preferably about 20 μm, and the dry film thickness of the polyurethane clearcoat coating layer formed from the two-component clearcoat composition may be from 10 to 70 μm, preferably from 25 to 50 μm, and more preferably about 45 μm.

As used herein, “orange peel” or the “orange peel effect” refers to a certain kind of finish that may develop on painted and cast surfaces. The texture resembles the surface of the skin of an orange. Gloss paint sprayed on a smooth surface (i.e. the body of a car) should also dry into a smooth surface. However, various factors can cause it to dry into a bumpy surface resembling the texture of an orange peel. The orange peel phenomenon can be minimized and/or prevented by changes to the materials used.

The instruments used to measure orange peel, such as, for example, a wavescan device simulate visual perception, such as, for example a Byk Wavescan device. Similar to human eyes the instruments optically scan the wavy light/dark pattern. A wavescan device similar to other orange peel meters uses a laser point light source to illuminate the specimen at a 60° angle and uses a detector to measure the reflected light intensity at the equal but opposite angle. The instrument is rolled across the surface and measures point by point the optical profile of the surface across a defined distance. The instruments analyze the structures according to their size. In order to simulate the human eye's resolution at various distances, the measurement signal is divided into several ranges using mathematical filter functions. In this manner, Wa corresponds to structures from 0.1 to 0.3 mm wavelength, Wb corresponds to structures from 0.3 to 1.0 mm wavelength, We corresponds to structures from 1.0 to 3.0 mm wavelength, Wd corresponds to structures from 3.0 to 10.0 wavelength, We corresponds to structures from 10 to 30 mm wavelength, SW (“short”) corresponds to structures from 0.3 to 1.2 mm wavelength, and LW (“long”) corresponds to structures from 1.2 to 12 mm wavelength. Structures smaller than 0.1 mm also influence visual perception, therefore the wavescan device measuring instruments may use a CCD camera to measure the diffused light caused by these fine structures. This parameter is referred to as “dullness”. The values of dullness, Wa, Wb, Wc, Wd, and We form a “structure spectrum”. This allows a detailed analysis of orange peel and its influencing factors, being material or application parameters. The detailed information of the structure spectrum as well as LW and SW form the basis to correlate to specific scales and to the distinctness of image (DOI) as described in for example ASTM E430.

In terms of the present disclosure, the two-component clearcoat crosslinked coating after curing on a substrate coated with a basecoat or the coated substrate obtained by the methods described herein has a Wb value of 5 to 45, preferably 10-40, preferably 15-35, preferably 20-30.

In terms of the present disclosure, the two-component clearcoat crosslinked coating after curing on a substrate coated with a basecoat or the coated substrate obtained by the methods described herein has a Wd value of 1 to 40, preferably 5-30, preferably 10-25, preferably 15-20. In a preferred embodiment, the Wb value of structures 0.3 to 1.0 mm wavelength as measured by a wavescan device of the two-component clearcoat crosslinked coating after curing on a substrate coated with a basecoat or the coated substrate obtained by the methods described herein is increased relative to an otherwise identical two-component clearcoat composition, method or coated substrate lacking the blocked isocyanate resin, preferably increased by 2-20 units. preferably 4-15 units, preferably 6-10 units. In a preferred embodiment, the Wd value of structures 3.0 to 10.0 mm wavelength as measured by a wavescan device of the two-component clearcoat crosslinked coating after curing on a substrate coated with a basecoat or the coated substrate obtained by the methods described herein is decreased or equal relative to an otherwise identical two-component clearcoat composition, method or coated substrate lacking the blocked isocyanate resin, preferably, if decreased, decreased by 1-10 units, preferably 2-6 units preferably 3-5 units.

As used herein, balance, structure balance, balance number, or balance value is the ratio of small waves and large waves and is evaluated based on “well balanced” structure spectrum curves found in visual correlation studies. Balance can be shifted from negative (longwave Wd dominant) to positive (shortwave Wb dominant) by increasing the amount of blocked isocyanate. An advantageous concentration can be identified to produce a well-balanced appearance. Formula (I) provides the relationship between Wd and Wb values and formula (II) provides a mean of calculating a balance value (B) using this relationship.

$$\begin{matrix}{W}_{b o} = 6 * \sqrt{{W}_{d}} + 4 & ( I ) \\ B = 10 * \frac{{W}_{b} - {W}_{bo}}{{W}_{b o}} & ( II )\end{matrix}$$

In terms of the present disclosure, the two-component clearcoat crosslinked coating after curing on a substrate coated with a basecoat or the coated substrate obtained by the methods described herein has a balance value as measured by a wavescan device of -4 to 6, preferably -2-5, preferably -1-4, preferably 0-2. In terms of the present disclosure, the two-component clearcoat crosslinked coating after curing on a substrate coated with a basecoat or the coated substrate obtained by the methods described herein has increased balance value as measured by a wavescan device relative to an otherwise identical two-component clearcoat composition, method or coated substrate lacking the blocked isocyanate resin, preferably increased by 0.2-10 units, preferably 0.5-8 units, preferably 1-6 units, preferably 2-4 units.

As used herein, the specular reflection gloss of a surface can be measured by a gloss meter. Gloss is determined by projecting a beam of light at a fixed intensity and angle onto a surface and measuring the amount of reflected light at an equal but opposite angle. There are a number of different geometries available for gloss measurement, each being dependent on the type of surface to be measured. Many international technical standards are available that define the method of use and specifications for different types of gloss meter used on various types of materials. The gloss meter provides a quantifiable way of measuring gloss intensity ensuring consistency of measurement by defining the precise illumination and viewing conditions. The configuration of both illumination source and observation reception angles allows measurement over a small range of the overall reflection angle. The measurement results of a gloss meter are related to the amount of reflected light from a black glass standard with a defined refractive index. The ratio of reflected to incident light for the specimen, compared to the ratio for the gloss standard, is recorded as gloss units (GU).

Measurement angle refers to the angle between the incident light and the perpendicular. Three measurement angles (20°, 60°, and 85°) are specified to cover the majority of industrial coating applications. The angle is selected based on the anticipated gloss range and to increase measurement accuracy. Medium gloss refers to a 10-70 GU 60° value, low gloss refers to a <10 GU 60° value and the test setup should be changed to 85°, and high gloss refers to a >70 GU 60° value and the test setup should be changed to 20°.

In terms of the present disclosure, the two-component clearcoat crosslinked coating after curing on a substrate coated with a basecoat or the coated substrate obtained by the methods described herein has a 20° gloss value of greater than 80 gloss units, preferably greater than 82 gloss units, preferably greater than 84 gloss units, preferably greater than 86 gloss units, preferably greater than 88 gloss units, preferably greater than 90 gloss units, preferably greater than 95 gloss units.

Thus, as described heretofore, the specific embodiments are as follows:

Embodiment 1: A two-component clearcoat composition, comprising:

a first component comprising a hydroxyl-functional resin; and a second component comprising a crosslinking agent which is a first isocyanate resin which is unblocked; and a blocked isocyanate resin which is a reacted form of a second isocyanate resin and a blocking agent; wherein the first component comprises the blocked isocyanate resin, the second component comprises the blocked isocyanate resin or the first and the second component comprise the blocked isocyanate resin, and wherein the first isocyanate resin and the second isocyanate resin are capable of reacting with the hydroxyl-functional resin to form a crosslinked coating.

Embodiment 2: The two-component clearcoat composition of embodiment 1, wherein the clearcoat composition comprises, based on a total weight of combined resin solids in the composition: from 10 to 90 percent by weight of the hydroxyl-functional resin; from 25 to 75 percent by weight of the first isocyanate resin; and from 0.1 to 15 percent by weight of the blocked isocyanate resin.

Embodiment 3: The two-component clearcoat composition of embodiment 1, wherein the hydroxyl-functional resin is a hydroxyl-functional acrylic resin or a hydroxyl-functional polyester resin.

Embodiment 4: The two-component clearcoat composition of embodiment 1, wherein the first isocyanate resin, the second isocyanate resin, or both are polyisocyanate resins comprising at least one diisocyanate selected from the group consisting of toluene diisocyanate, diphenylmethane-4,4′-diisocyanate, diphenylmethane-2,4′-diisocyanate, hexamethylene diisocyanate, bis(4-isocyanatocyclohexyl) methane, and isophorone diisocyanate.

Embodiment 5: The two-component clearcoat composition of embodiment 1, wherein the blocking agent is at least one selected from the group consisting of an alkyl alcohol, an ether alcohol, an oxime, an amine, an amide, and a hydroxylamine.

Embodiment 6: The two-component clearcoat composition of embodiment 1, wherein the blocking agent is at least one selected from the group consisting of imidazole, dimethylpyrazole, and diethylmalonate.

Embodiment 7: The two-component clearcoat composition of embodiment 1, wherein greater than 80% by weight of the blocked isocyanate resin is present in the first component, relative to the total weight of the blocked isocyanate in the two-component clearcoat composition.

Embodiment 8: The two-component clearcoat composition of embodiment 1, wherein the first isocyanate resin and the second isocyanate resin are the same.

Embodiment 9: The two-component clearcoat composition of embodiment 1, wherein the first isocyanate resin and the second isocyanate resin are different.

Embodiment 10: The two-component clearcoat composition of embodiment 1, wherein the coating composition comprises, based on a total weight of combined resin solids in the composition, from 2 to 10 percent by weight of the blocked isocyanate resin. Embodiment 11: The two-component clearcoat composition of embodiment 1, wherein a Wb value of structures of 0.3 to 1.0 mm wavelength as measured by a wavescan device of the crosslinked coating after curing on a substrate coated with a black basecoat is increased 4 units or more relative to an otherwise identical two-component clearcoat composition lacking the blocked isocyanate resin while having the same molar amount of total isocyanate.; and a Wd value of structures of 3.0 to 10.0 mm wavelength as measured by a wavescan device of the crosslinked coating after curing on a substrate coated with a black basecoat is decreased by less than or equal to 4 units relative to an otherwise identical two-component clearcoat composition lacking the blocked isocyanate resin while having the same molar amount of total isocyanate.

Embodiment 12: The two-component clearcoat composition of embodiment 1, wherein a balance value as measured by a wavescan device of the crosslinked coating after curing on a substrate coated with a black basecoat is increased relative to an otherwise identical two-component clearcoat composition lacking the blocked isocyanate resin while having the same molar amount of total isocyanate.

Embodiment 13: The two-component clearcoat composition of embodiment 1, wherein a balance value as measured by a wavescan device of the crosslinked coating after curing on a substrate coated with a basecoat is −4 to 6.

Embodiment 14: The two-component clearcoat composition of embodiment 1, wherein a 20° gloss value of the crosslinked coating after curing on a substrate coated with a basecoat is greater than 80 gloss units.

Embodiment 15: The two-component clearcoat composition of embodiment 1, wherein a Wb value of structures of 0.3 to 1.0 mm wavelength as measured by a wavescan device of the crosslinked coating after curing on a substrate coated with a silver metallic basecoat is increased by no more than 4 units to an otherwise identical two-component clearcoat composition lacking the blocked isocyanate.

Embodiment 16: A method of forming a coated substrate, the method comprising: coating a surface of the substrate with a basecoat composition to obtain a basecoat layer; at least partially drying the basecoat layer; preparing a two-component clearcoat composition by mixing a first component comprising a hydroxyl-functional resin; a second component comprising a crosslinking agent which is a first isocyanate resin which is unblocked; and an organic solvent; wherein at least one of the first component and the second component further comprises a blocked isocyanate which is a reacted form of a second isocyanate resin and a blocking agent;

thereby forming the clearcoat composition; applying the clearcoat composition to a surface of the basecoat layer to form a clearcoat composition layer; reacting and curing the hydroxyl-functional resin with the first isocyanate resin and the second isocyanate resin obtained by unblocking the blocked isocyanate resin during the curing to form a polyurethane clearcoat coating layer thereby forming a coated substrate; wherein the coated substrate comprises the basecoat layer between the substrate and the polyurethane clearcoat coating layer; wherein a delayed reaction of the second isocyanate resin during the reacting and the curing reduces a rate of cure of the polyurethane clearcoat coating layer such that a wrinkle is formed between the basecoat layer and the polyurethane clearcoat coating layer and the Wb value of structures 0.3 to 1.0 mm wavelength as measured by a wavescan device of the coated substrate is increased.

Embodiment 17: The method of embodiment 16, wherein the clearcoat composition comprises, based on a total weight of combined resin solids in the clearcoat composition: from 10 to 90 percent by weight of the hydroxyl-functional resin; from 25 to 75 percent by weight of the first isocyanate resin; and from 0.1 to 15 percent by weight of the blocked isocyanate resin. Embodiment 18: The method of embodiment 16, wherein the hydroxyl-functional resin is a hydroxyl-functional acrylic resin or a hydroxyl-functional polyester resin.

Embodiment 19: The method of embodiment 16, wherein the first isocyanate resin, the second isocyanate resin, or both are polyisocyanate resins comprising at least one diisocyanate selected from the group consisting of toluene diisocyanate, diphenylmethane-4,4′-diisocyanate, diphenylmethane-2,4′-diisocyanate, hexamethylene diisocyanate, bis(4-isocyanatocyclohexyl) methane, and isophorone diisocyanate.

Embodiment 20: The method of embodiment 16, wherein the blocking agent is at least one selected from the group consisting of an alkyl alcohol, an ether alcohol, an oxime, an amine, an amide, and a hydroxylamine.

Embodiment 21: The method of embodiment 16, wherein the blocking agent is at least one selected from the group consisting of imidazole, dimethylpyrazole, and diethylmalonate.

Embodiment 22: The method of embodiment 16, wherein the clearcoat composition comprises, based on a total weight of combined resin solids in the clearcoat composition, from 2 to 10 percent by weight of the blocked isocyanate resin.

Embodiment 23: The method of embodiment 16, wherein greater than 80% by weight of the blocked isocyanate resin is present in the first component, relative to the total weight of the blocked isocyanate in the clearcoat composition.

Embodiment 24: The method of embodiment 16, wherein the basecoat is black and the coated substrate has an increased Wb value of structures of 0.3 to 1.0 mm wavelength and a decreased or equal Wd value of structures of 3.0 to 10.0 mm wavelength as measured by a wavescan device relative to an otherwise identical method lacking the blocked isocyanate resin while having the same molar amount of total isocyanate.

Embodiment 25: The method of embodiment 16, wherein the basecoat is black and the coated substrate has an increased balance value as measured by a wavescan device relative to an otherwise identical method lacking the blocked isocyanate resin while having the same molar amount of total isocyanate.

Embodiment 26: The method of embodiment 16, wherein the coated substrate has a balance value as measured by a wavescan device of -4 to 6.

Embodiment 27: The method of embodiment 16, wherein the coated substrate has a 20° gloss value of greater than 80 gloss units.

Embodiment 28: The method of embodiment 16, wherein the curing is performed at a temperature of 80-150° C. for a time period of 15-45 minutes.

Embodiment 29: The method of embodiment 16, wherein the basecoat is silver metallic and the coated substrate has an increased Wb value of structures of 0.3 to 1.0 mm wavelength as measured by a wavescan device of less than 4 units relative to an otherwise identical method lacking the blocked isocyanate.

Embodiment 30: A coated substrate obtained by the method of embodiment 16.

Embodiment 31: The coated substrate of embodiment 30 wherein the basecoat is black and which has an increased Wb value of structures of 0.3 to 1.0 mm wavelength and a decreased or equal Wd value of structures of 3.0 to 10.0 mm wavelength as measured by a wavescan device relative to an otherwise identical coated substrate obtained by an otherwise identical method lacking the blocked isocyanate resin while having the same molar amount of total isocyanate.

Embodiment 32: The coated substrate of embodiment 30 wherein the basecoat is black and which has an increased balance value as measured by a wavescan device relative to an otherwise identical coated substrate obtained by an otherwise identical method lacking the blocked isocyanate resin while having the same molar amount of total isocyanate while having the same molar amount of total isocyanate.

Embodiment 33: The coated substrate of embodiment 30 which has a balance value as measured by a wavescan device of -4 to 6,

Embodiment 34: The coated substrate of embodiment 30 which has a 20° gloss value of greater than 80 gloss units,

Embodiment 35: The coated substrate of embodiment 30, wherein the basecoat is metallic silver and which has an increased Wb value of structures of 0.3 to 1.0 mm wavelength as measured by wavescan device of less than 4 units relative to an otherwise identical coated substrate obtained by an otherwise identical method lacking the blocked isocyanate resin.

Embodiment 36: A kit, comprising: a first component comprising a hydroxyl-functional resin; a second component comprising a crosslinking agent which is a first isocyanate resin; and a blocked isocyanate resin which comprises a reacted form of a second isocyanate resin and a blocking agent; wherein the blocked isocyanate resin is present in the first component, the second component, or both; and wherein the first isocyanate resin, the second isocyanate resin, or both are capable of reacting with the hydroxyl-functional resin to form a crosslinked coating.

The examples below are intended to further illustrate protocols for preparing and characterizing the two-component clearcoat compositions of the present disclosure. Further, they are intended to illustrate assessing the properties of these materials and assessing their performance, especially visual appearance, on coated substrates. They are not intended to limit the scope of the claims:

### Test Methods Polymer Molecular Weight Determination

To determine polymer molecular weights by GPC, fully dissolved molecules of a polymer sample are fractionated on a porous column stationary phase. A 0.1 mol/l acetic acid solution in tetrahydofuran (THF) is used as the eluent solvent. The stationary phase is combination of Waters Stvragel HR 5, HR 4, HR 3, and HR 2 columns. Five milligrams of sample are added to 1.5 mL of eluent solvent and filtered through a 0.5 μm filter. After filtering, 100 μl of the polymer sample solution is injected into the column at a flow rate of 1.0 ml/min. Separation takes place according to the size of the polymer coils which form in the eluent solvent. Small molecules diffuse into the pores of the column material more frequently and are therefore retarded more than large molecules. Thus, large molecules are eluted earlier than small molecules. The molecular weight distribution, the averages Mₙ and M_{w} and the polydispersity M_{w}/Mₙ of the polymer samples are calculated with the aid of chromatography software utilizing a calibration curve generated with the EasyValid validation kit which includes a series of unbranched-polystyrene standards of varied molecular weights available from Polymer Standards Service.

### EXAMPLE 1

### Preparation of Coated Substrates

Aluminum test panels measuring 8″×20″ were used as a substrate. The test panels were coated using a BASF waterborne basecoat of 0.5-0.8 mL applied to the panel in two coats. The basecoats include a black basecoat (BASF E211KU015) and a silver metallic basecoat (BASF E211AW628A). After coating with the basecoat the panels receive a 5 minute ambient flash and a 6 minute heated flash at 150° F. (65.56° C.). Subsequently a solventbome two-component clearcoat wedge of 1.2-2.6 mL was applied to the panel in two coats, After coating the panels receive a 10-minute ambient flash and a 20-minute bake at a temperature of 285° F. (140.56° C.). Although the examples below feature vertical panels that were coated, flashed and baked vertically, it is equally envisaged that horizontal panels may be coated, flashed and baked horizontally.

Table 1 summarizes the general composition of the solventbome two-component clearcoat compositions prepared.

TABLE 1

| | | Wt. | Weight | Solids | Eq. |
|---|---|---|---|---|---|
| | | (g) | range (g) | percentage | wt. |
| Component | Resin 1 | 55.96 | 40-60 | 67.5 | 318 |
| A | Resin 2 | 11.08 | 9-12 | 62.5 | 271 |
| | Hydrophobic | 5.32 | 4.5-6 | 27.47 | |
| | fumed silica | | | | |
| | dispersion in | | | | |
| | acrylic copolymer | | | | |
| | UVA | 2.26 | 2-3 | 100 | |
| | Leveling agent | 0.073 | 0.06-0.08 | 52 | |
| | HALS | 0.769 | 0.6-0.9 | 100 | |
| | Oil based reactive | 2.904 | 2-5 | 100 | 154 |
| | diluent | | | | |
| | Solvent | 22.95 | 20-30 | 0 | |
| | Blocked | 1.64 | 0-15 | 60-75 | |
| | isocyanate | | | | |
| Component | Unblocked | 36.9 | 22-38 | 71.7 | |
| B | polyisocyanate | | | | |

The two component clearcoat composition general comprises a component A and a component B. Although the examples below feature the blocked isocyanate in the component A, it is equally envisaged that the blocked isocyanate may be present in the component A, the component B, or both. The component A. generally comprises an acrylic copolymer (resin 1 and resin 2) having a glass transition temperature of ˜36° C., a molecular weight of 5500, an OH-value of 185, a solids content of 65% and an eq. wt of 295 as well as a polyester polyol having a molecular weight of 400, an OH-value of 365, a solids content of 100% and an eq. wt. of 154. The polyester polyol may serve as an oil based reactive diluent or polyester resin. The component A may further comprise a hydrophobic fumed silica dispersion in acrylic copolymer, a liquid UV absorber (Tinuvin® 384, UVA), a leveling agent (polysiloxane), a liquid hindered amine light stabilizer (Tinuvin® 123, HALS), a solvent (propylene glycol methyl ether), amounts of blocked isocyanate (Desmodur® PL350, Desmodur® PL340, Desmodur® BL3475, Duranate® MFK-60B, and mixtures thereof) were blended into an Automotive OEM 2K Clear.

The blocked version of the isocyanate can be added to either the A-component, B-component or both. The component B generally comprises a blend of live/unblocked polyisocyanate (Desmodus® Z4470SN and Desmodur® N3990).

Table 2 summarizes the composition of a two component clearcoat incorporating Desmodus®

PL350 dimethylpyrrazole (DMP) blocked hexamethylene diisocyanates (HDI) at 2.5%, 5.0% and 10%.

TABLE 2

| | | | 2 | 3 | 4 |
|---|---|---|---|---|---|
| | | 1 | 2.5% | 5.0% | 10% |
| | | 0% | DMP | DMP | DMP |
| | Sample | blocked | blocked | blocked | blocked |
| | Composition | isocyanate | HDI | HDI | HDI |
| Component | Acrylic copolymer | 67 | 65 | 63 | 59 |
| A | Hydrophobic | 5.25 | 5.25 | 5.25 | 5.25 |
| | fumed silica | | | | |
| | dispersion in | | | | |
| | acrylic copolymer | | | | |
| | Tinuvin 384 UVA | 2.23 | 2.23 | 2.23 | 2.23 |
| | Polysiloxane | 0.07 | 0.07 | 0.07 | 0.07 |
| | leveling agent | | | | |
| | Tinuvin 123 | 0.76 | 0.76 | 0.76 | 0.76 |
| | Polyester polyol | 3 | 3 | 3 | 3 |
| | resin | | | | |
| | Propylene glycol | 23 | 23 | 23 | 23 |
| | methyl ether | | | | |
| | Desmodur PL350 | 0 | 1.52 | 3.05 | 6.11 |
| | Duranate | 0 | 0 | 0 | 0 |
| | MF-K60B | | | | |
| | Desmodur BL3475 | 0 | 0 | 0 | 0 |
| Component | Blend of 10 parts | 36.5 | 34.4 | 32.2 | 28.7 |
| B | of Desmodur | | | | |
| | Z4470SN and 72 | | | | |
| | parts Desmodur | | | | |
| | N3390 in 18 parts | | | | |
| | solvent | | | | |

Table 3 summarizes the composition of a two component clearcoat incorporating Desmodur® PL340 dimethylpyrrazole (DMP) blocked hexamethylene diisocyanates (HD) and isophorone diisocyanates (IPDI) at 2.5%, 5.0% and 10%.

TABLE 3

| | | | 5 | 6 | 7 |
|---|---|---|---|---|---|
| | | 1 | 2.5% | 5.0% | 10% |
| | | 0% | DMP | DMP | DMP |
| | | blocked | blocked | blocked | blocked |
| | Sample | isocy- | IPDI/ | IPDI/ | IPDI/ |
| | Composition | anate | HDI | HDI | HDI |
| Component | Acrylic | 67 | 65 | 64 | 60 |
| A | copolymer | | | | |
| | Hydrophobic | 5.25 | 5.25 | 5.25 | 5.25 |
| | fumed silica | | | | |
| | dispersion in | | | | |
| | acrylic | | | | |
| | copolymer | | | | |
| | Tinuvin 384 | 2.23 | 2.23 | 2.23 | 2.23 |
| | UVA | | | | |
| | Polysiloxane | 0.07 | 0.07 | 0.07 | 0.07 |
| | leveling agent | | | | |
| | Tinuvin 123 | 0.76 | 0.76 | 0.76 | 0.76 |
| | Polyester polyol | 3 | 3 | 3 | 3 |
| | resin | | | | |
| | Propylene glycol | 23 | 23 | 23 | 23 |
| | methyl ether | | | | |
| | Desmodur | 0 | 2.05 | 4.09 | 8.2 |
| | PL340 | | | | |
| | Duranate | 0 | 0 | 0 | 0 |
| | MF-K60B | | | | |
| | Desmodur | 0 | 0 | 0 | 0 |
| | BL3475 | | | | |
| Component | Blend of | 36.5 | 35.2 | 33.5 | 29.8 |
| B | 10 parts | | | | |
| | of Desmodur | | | | |
| | Z4470SN and 72 | | | | |
| | parts Desmodur | | | | |
| | N3390 in | | | | |
| | 18 parts solvent | | | | |

Table 4 summarizes the composition of a two component clearcoat incorporating Desmodur® BL3475 diethylmaolonate (DEM) blocked hexamethylene diisocyanates (HDI) and isophorone diisocyanates (IPDI) at 2.5%, 5.0% and 10%.

TABLE 4

| | | | 8 | 9 | 10 |
|---|---|---|---|---|---|
| | | 1 | 2.5% | 5.0% | 10% |
| | | 0% | DEM | DEM | DEM |
| | | blocked | blocked | blocked | blocked |
| | Sample | isocy- | IPDI:HDI | IPDI:HDI | IPDI:HDI |
| | Composition | anate | 1:1 | 1:1 | 1:1 |
| Compo- | Acrylic | 67 | 65 | 63 | 60 |
| nent A | copolymer | | | | |
| | Hydrophobic | 5.25 | 5.25 | 5.25 | 5.25 |
| | fumed silica | | | | |
| | dispersion in | | | | |
| | acrylic | | | | |
| | copolymer | | | | |
| | Tinuvin 384 | 2.23 | 2.23 | 2.23 | 2.23 |
| | UVA | | | | |
| | Polysiloxane | 0.07 | 0.07 | 0.07 | 0.07 |
| | leveling agent | | | | |
| | Tinuvin 123 | 0.76 | 0.76 | 0.76 | 0.76 |
| | Polyester polyol | 3 | 3 | 3 | 3 |
| | resin | | | | |
| | Propylene glycol | 23 | 23 | 23 | 23 |
| | methyl ether | | | | |
| | Desmodur | 0 | 0 | 0 | 0 |
| | PL340 | | | | |
| | Duranate | 0 | 0 | 0 | 0 |
| | MF-K60B | | | | |
| | Desmodur | 0 | 1.64 | 3.28 | 6.56 |
| | BL3475 | | | | |
| Compo- | Blend of | 36.5 | 35.2 | 33.4 | 29.9 |
| nent B | 10 parts | | | | |
| | of Desmodur | | | | |
| | Z4470SN | | | | |
| | and 72 | | | | |
| | parts Desmodur | | | | |
| | N3390 in | | | | |
| | 18 parts | | | | |
| | solvent | | | | |

Table 5 summarizes the composition of a two component clearcoat incorporating Duranate® MFK60B diethylmaolonate (DEM) blocked hexamethylene diisocy ates (HDI) at 1.0%, 2.5% and 5.0%.

TABLE 5

| | | 1 | 11 | 12 | 13 |
|---|---|---|---|---|---|
| | | 0% | 1.0% | 2.5% | 5.0% |
| | | blocked | DEM | DEM | DEM |
| | Sample | isocy- | blocked | blocked | blocked |
| | Composition | anate | HDI | HDI | HDI |
| Component | Acrylic | 67 | 66 | 65 | 63 |
| A | copolymer | | | | |
| | Hydrophobic | 5.25 | 5.25 | 5.25 | 5.25 |
| | fumed silica | | | | |
| | dispersion in | | | | |
| | acrylic copolymer | | | | |
| | Tinuvin 384 | 2.23 | 2.23 | 2.23 | 2.23 |
| | UVA | | | | |
| | Polysiloxane | 0.07 | 0.07 | 0.07 | 0.07 |
| | leveling agent | | | | |
| | Tinuvin 123 | 0.76 | 0.76 | 0.76 | 0.76 |
| | Polyester polyol | 3 | 3 | 3 | 3 |
| | resin | | | | |
| | Propylene glycol | 23 | 23 | 23 | 23 |
| | methyl ether | | | | |
| | Desmodur | 0 | 0 | 0 | 0 |
| | PL340 | | | | |
| | Duranate | 0 | 0.82 | 2 | 4 |
| | MF-K60B | | | | |
| | Desmodur | 0 | 0 | 0 | 0 |
| | BL3475 | | | | |
| Component | Blend of | 36.5 | 36.2 | 35.2 | 33 |
| B | 10 parts | | | | |
| | of Desmodur | | | | |
| | Z4470SN and 72 | | | | |
| | parts Desmodur | | | | |
| | N3390 in 18 | | | | |
| | parts solvent | | | | |

Table 6 summarizes the composition of a two component clearcoat incorporating a blend of Desmodur® BL3475 and Duranateg MFK60B diethylmaolonate (DEM) blocked hexamethylene diisocyanates (HDI) and isophorone diisocyanates (IPDI) at 1.0%, 2.5%, 5.0% and 10%.

TABLE 6

| | | 14 | 15 | 16 | 17 |
|---|---|---|---|---|---|
| | | 1.0% | 2.5% | 5.0% | 10% |
| | | blocked | blocked | blocked | blocked |
| | Sample | DEM | DEM | DEM | DEM |
| | Composition | blend | blend | blend | blend |
| Component A | Acrylic copolymer | 66 | 65 | 63 | 60 |
| | Hydrophobic | 5.25 | 5.25 | 5.25 | 5.25 |
| | fumed silica | | | | |
| | dispersion in | | | | |
| | acrylic copolymer | | | | |
| | Tinuvin 384 UVA | 2.23 | 2.23 | 2.23 | 2.23 |
| | Polysiloxane | 0.07 | 0.07 | 0.07 | 0.07 |
| | leveling agent | | | | |
| | Tinuvin 123 | 0.76 | 0.76 | 0.76 | 0.76 |
| | Polyester polyol | 3 | 3 | 3 | 3 |
| | resin | | | | |
| | Propylene glycol | 23 | 23 | 23 | 23 |
| | methyl ether | | | | |
| | Desmodur PL350 | 0 | 0 | 0 | 0 |
| | Duranate | 0.41 | 1 | 2 | 4.1 |
| | MF-K60B | | | | |
| | Desmodur | 0.33 | 0.8 | 1.6 | 3.3 |
| | BL3475 | | | | |
| Component B | Blend of 10 parts | 36.5 | 36 | 35.2 | 33.5 |
| | of Desmodur | | | | |
| | Z4470SN and 72 | | | | |
| | parts Desmodur | | | | |
| | N3390 in 18 parts | | | | |
| | solvent | | | | |

### EXAMPLE 2

### Visual Appearance Analysis of Coated Substrates

After baking panels were evaluated for appearance using a Wavescan Dual laser refractive appearance instrument. The balance number was calculated by the equations of formula (I) and formula (II). Formula (I) provides the relationship between Wd and Wb values and formula (II) provides a mean of calculating a balance value (B) using this relationship.

$$\begin{matrix}{W}_{b o} = 6 * \sqrt{{W}_{d}} + 4 & ( I ) \\ B = 10 * \frac{{W}_{b} - {W}_{bo}}{{W}_{b o}} & ( II )\end{matrix}$$

The disclosure used the clearcoat rate of cure layer to provide a subtle wrinkle between the color layer (basecoat) and the clearcoat layer. This effect reduces the visibility of larger wavelength peel, commonly referred to as “orange peel”. OEM manufacturers are continually pushing their paint suppliers to improve appearance. Specifically, they are looking for an improved ratio of Longwave (LW) to Shortwave (SW) as measured by a Byk Wavescan device. This ratio is also referred to as balance. By blending in small amounts of blocked isocyanate (10% or less of fixed vehicle) to live 2K clearcoat, an improved balance cured coating is achieved. Balance can be shifted from negative (longwave dominant) to positive (shortwave dominant) by increasing the amount of blocked isocyanate. Advantageous concentrations can be identified to produce a well-balanced appearance. Table 7 summarizes the effects of varying concentrations of the blocked isocyanates (PL350, PL340, BL3475, and MF-K60B) in a 2.2 mL clearcoat vertical film over a black basecoat (BASF E211KU015)

TABLE 7

| Sample | Wb | Wd | B | R-Value |
|---|---|---|---|---|
| 1 comparative | 15 | 12.9 | −4.05 | 9.1 |
| 2 2.5% PL350 | 19 | 12.9 | −2.56 | 9 |
| 3 5.0% PL350 | 25 | 10.5 | 0.665 | 9.4 |
| 4 10% PL350 | 39 | 14.4 | 4.38 | 4.4 |
| 1 comparative | 19.2 | 15.7 | −3.09 | 8.3 |
| 5 2.5% PL340 | 27.9 | 13.3 | 0.78 | 8.7 |
| 6 5.0% PL340 | 34.1 | 13.3 | 3.17 | 8.5 |
| 7 10% PL340 | 37.1 | 14 | 4.03 | 8.3 |
| 1 comparative | 19.6 | 12.7 | −2.28 | 8.7 |
| 8 2.5% BL3475 | 34.8 | 15.8 | 2.5 | 7.9 |
| 9 5.0% BL3475 | 39.3 | 17.3 | 3.57 | 7.6 |
| 10 10% BL3475 | 40.8 | 17.2 | 4.13 | 7.6 |
| 11 1.0% MFK60B | 20.7 | 13 | 13 | 8.73 |
| 12 2.5% MFK60B | 24.5 | 16 | 16 | 8.06 |
| 13 5.0% MFK60B | 36.3 | 14.8 | 14.8 | 8.15 |

Table 8 summarizes the effects of varying concentrations of a blended blocked isocyanate (BL3475 and MFK60B) in a 2.2 mL clearcoat vertical film over a black basecoat (BASF E211KU015) and a silver metallic basecoat (BASF E211AW628A).

TABLE 8

| Sample | Wb | Wd | B | R-Value | |
|---|---|---|---|---|---|
| 1 comparative | 12.7 | 18.2 | −5.7 | 8 | Black |
| 14 1.0% blend | 12.1 | 17.1 | −5.8 | 8.07 | basecoat |
| 15 2.5% blend | 18.7 | 17.3 | −3.54 | 7.81 | E211KU015 |
| 16 5.0% blend | 19.8 | 19.1 | −3.45 | 7.7 | |
| 17 10% blend | 24.5 | 19.7 | −2 | 7.67 | |
| 1 comparative | 33.4 | 18.5 | 1.2 | 7.46 | Silver |
| 14 1.0% blend | 33.9 | 17 | 1.8 | 7.83 | basecoat |
| 15 2.5% blend | 34.3 | 17.4 | 1.82 | 7.66 | E211AW628A |
| 16 5.0% blend | 31.6 | 15.7 | 1.38 | 7.64 | |
| 17 10% blend | 33.5 | 18.2 | 1.32 | 7.41 | |

As indicated, the two-component clearcoat compositions of the present disclosure are suitable for increasing the shortwave structure (Wb) over a black basecoat without significantly increasing the longwave structure (Wd) (Table 7). Additionall_{y}, the two component clearcoat compositions of the present disclosure are suitable for increasing the shortwave structure over a black basecoat without significantly increasing the shortwave structure over a silver metallic basecoat (Table 8).

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present invention is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A two-component clearcoat composition, comprising:
a first component comprising a hydroxyl-functional resin;
a second component comprising a crosslinking agent being a first isocyanate resin which is not blocked; and a blocked isocyanate resin which is a reacted form of a second isocyanate resin and blocking agent; wherein
the first component comprises the blocked isocyanate resin, the second component comprises the blocked isocyanate resin or the first and the second component comprise the blocked isocyanate resin, and the first isocyanate resin and the second isocyanate resin are capable of reacting with the hydroxyl-functional resin to form a crosslinked coating.

2. The two-component clearcoat composition according to claim 1, wherein
a content of the hydroxyl-functional resin is from 10 to 90 percent by weight;
a content of the first isocyanate resin is from 25 to 75 percent by weight; and
a content of the blocked isocyanate resin is from 0.1 to 15 percent by weight;
wherein the per cent by weight values are based on a total weight of resin solids of the first and second components, and
a Wb value of structures of 0.3 to 1.0 mm wavelength as measured by a wavescan device of the crosslinked coating after curing on a substrate coated with a black basecoat is increased 4 units or more relative to an otherwise identical two-component clearcoat composition lacking the blocked isocyanate resin; and
a Wd value of structures of 3.0 to 10.0 mm wavelength as measured by a wavescan device of the crosslinked coating after curing on a substrate coated black basecoat is decreased by less than or equal to 4 units relative to an otherwise identical two-component clearcoat composition lacking the blocked isocyanate resin while having the same molar amount of total isocyanate.

3. The two-component clearcoat composition according to claim 1, wherein the hydroxyl-functional resin comprises at least one of a hydroxyl-functional acrylic resin and a hydroxyl-functional polyester resin.

4. The two-component clearcoat composition according to claim 1, wherein the first isocyanate resin, the second isocyanate resin, or both are polyisocyanate resins comprising at least one diisocyanate selected from the group consisting of toluene diisocyanate, diphenylmethane-4,4′-diisocyanate, diphenylmethane-2,4′-diisocyanate, hexamethylene diisocyanate, bis(4-isocyanatocyclohexyl) methane, and isophorone diisocyanate.

5. The two-component clearcoat composition according to claim 1, wherein the blocking agent for the second isocyanate resin is at least one compound selected from the group consisting of an alkyl alcohol, an ether alcohol, diethylmalonate, an oxime, an amine, an amide, and a hydroxylamine.

6. The two-component clearcoat composition according to claim 1, wherein a balance value as measured by a wavescan device of the crosslinked coating after curing on a substrate coated with a black basecoat is increased relative to an otherwise identical two-component clearcoat composition lacking the blocked isocyanate resin while having the same molar amount of total isocyanate.

7. The two-component clearcoat composition according to claim 1, wherein a balance value as measured by a wavescan device of the crosslinked coating after curing on a substrate coated with a basecoat is −4 to 6.

8. The two-component clearcoat composition according to claim 1, wherein a 20° gloss value of the crosslinked coating after curing on a substrate coated with a basecoat is greater than 80 gloss units.

9. A method of forming a coated substrate with the two-component clearcoat composition according to claim 1, the method comprising:
coating a surface of the substrate with a basecoat composition to obtain a basecoat layer;
at least partially drying the basecoat layer;
preparing a two-component clearcoat composition by mixing the first and second components of the two-component clearcoat composition with an organic solvent thereby forming a clearcoat composition;
applying the clearcoat composition to a surface of the basecoat layer to form a clearcoat composition layer;
reacting and curing the hydroxyl-functional resin with the first isocyanate resin and the second isocyanate resin obtained by unblocking the blocked isocyanate resin during the curing to form a polyurethane clearcoat coating layer on the basecoat layer;
wherein a delayed reaction of the second isocyanate resin during the reacting and the curing reduces a rate of cure of the polyurethane clearcoat coating layer such that a wrinkle is formed between the basecoat layer and the polyurethane clearcoat coating layer.

10. The method according to claim 9, wherein a content of the blocked isocyanate resin in the clearcoat composition is from 2 to 10 percent by weight, based on the total weight of resin solids in the clearcoat composition.

11. The method according to claim 9, wherein the curing is performed at a temperature of 80-150° C. for a time period of 15-45 minutes.

12. A coated substrate obtained by the method according to claim 9, wherein the basecoat is black and has an increased Wb value of structures of 0.3 to 1.0 mm wavelength and a decreased or equal Wd value of structures of 3.0 to 10.0 mm wavelength as measured by a wavescan device relative to an otherwise identical coated substrate obtained by an otherwise identical method having the same total molar amount of isocyanate while lacking the blocked isocyanate resin.

13. A coated substrate obtained by the method according to claim 9, wherein the basecoat is silver metallic and the coated substrate has an increased Wb value of structures of 0.3 to 1.0 mm wavelength as measured by a wavescan device of less than 4 units relative to an otherwise identical method having the same total molar amount of isocyanate while lacking the blocked isocyanate resin.

14. A kit, comprising:
a first component comprising a hydroxyl-functional resin;
a second component comprising a crosslinking agent being a first isocyanate resin which is not blocked; and a blocked isocyanate resin which is a reacted form of a second isocyanate resin and a blocking agent; wherein
the first component comprises the blocked isocyanate resin, the second component comprises the blocked isocyanate resin or the first and the second component comprise the blocked isocyanate resin, and the first isocyanate resin and the second isocyanate resin are capable of reacting with the hydroxyl-functional resin to form a crosslinked coating.

15. The kit according to claim 14, wherein
a content of the hydroxyl-functional resin is from 10 to 90 percent by weight;
a content of the first isocyanate resin is from 25 to 75 percent by weight; and
a content of the blocked isocyanate resin is from 0.1 to 15 percent by weight;
wherein the per cent by weight values are based on a total weight of resin solids of the first and second components, and
a Wb value of structures of 0.3 to 1.0 mm wavelength as measured by a wavescan device of the crosslinked coating after curing on a substrate coated with a black basecoat is increased 4 units or more relative to an otherwise identical two-component clearcoat composition lacking the blocked isocyanate resin; and
a Wd value of structures of 3.0 to 10.0 mm wavelength as measured by a wavescan device of the crosslinked coating after curing on a substrate coated with a black basecoat is decreased by less than or equal to 4 units relative to an otherwise identical two-component clearcoat composition lacking the blocked isocyanate resin.

16. The two-component clearcoat composition according to claim 5, wherein the blocking agent for the second isocyanate resin is at least one compound selected from the group consisting of imidazole and dimethylpyrazole.
